(19) United States
(12) Patent Application Publication
(10) Pub. No.: US 2011/0119529 A1
(43) Pub. Date: May 19, 2011

(54) VIRTUAL HARD DISK DRIVE

(75) Inventors: Chih-Wei CHEN, TAIPEI CITY (TW); Hsiao-Fen LU, TAIPEI CITY (TW)

(73) Assignee: INVENTEC CORPORATION, TAIPEI CITY (TW)

(21) Appl. No.: 12/690,113

(22) Filed: Jan. 20, 2010

(30) Foreign Application Priority Data
Nov. 18, 2009 (TW) 98139188

(51) Int. Cl. G06F 11/26

(52) U.S. Cl. 714/29; 714/28; 714/E11.168

(57) ABSTRACT

A virtual hard disk drive includes at least one test transmission interface and a processing unit, wherein the test transmission interface is used for electrically connecting with the processing unit. The test transmission interface can electrically connect with a transmission interface under test of a computer. The processing unit includes an obtaining module and a simulation module. When an access instruction is received through the test transmission interface from the transmission interface under test of the computer, the obtaining module obtains a number of accessed blocks from the access instruction. The simulation module simulates a step of accessing a set of accessed data with the number of accessed blocks with respect to the transmission interface under test via the test transmission interface.

### RELATED APPLICATIONS

This application claims priority to Taiwan Application Serial Number 98139188, filed Nov. 18, 2009, which is herein incorporated by reference.

### BACKGROUND

1. Field of Invention

The present invention relates to a virtual hard disk drive (HDD).

2. Description of Related Art

Small Computer System Interface (SCSI) is processor standards used between computers and peripheral devices (hard disk drives, floppy disk drives, optical disk drives, printers, scanners, etc). The SCSI standards define commands, communication protocols, and electrical characteristics of entities, wherein the SCSI standards are commonly used in the storage devices (such as hard disk drives or magnetic tape drives), and have been used in the transmission interfaces of the advanced enterprise hard disk drives for a long time. Next, due to the explosive-growing of the amount of data, the industry has developed several relatively fast transmission interfaces, such as Serial Attached SCSI (SAS) and Fibre Channel (FC), to replace the transmission interfaces with the SCSI standards.

In the promotion of relatively fast transmission speeds, the stability and the maximum affordability of transmission interfaces are also the major consideration during designing the transmission interfaces of a system. Therefore, a pressure test is performed to continuously apply pressure on a transmission interface, and thereby an observation is taken to decide what the pressure is, wherein the transmission interface crashes under the pressure. The observation is also taken to make sure if the transmission interface fails and recovers gracefully when the transmission interface crashes. The purpose of the pressure test is to ensure that the transmission interface fails and recovers gracefully.

In the prior art, several hard disk drives are connected to a transmission interface under test, and thereby a great deal of reading and writing is performed in the hard disk drives via the transmission interface under test to perform a pressure test. However, an efficiency of traditional hard disk drives is too poor, and therefore the pressure test cannot actually present the efficiency of the transmission interface under test. Moreover, after the pressure test is performed many times, the hard disk drives will easily obtain damaged sectors caused by the great deal of reading and writing, which lasts for a long time in the pressure tests. Thus, when the pressure tests are performed on the transmission interfaces, it is required to change the hard disk drives regularly, and thereby the cost of the pressure tests will be increased.

### SUMMARY

Therefore, according to one aspect of the present invention, a virtual hard disk drive is provided to emulate accessing data according to an access instruction received from a transmission interface under test of a computer. The virtual hard disk drive includes at least one test transmission interface and a processing unit, wherein the test transmission interface is used for electrically connecting with the processing unit. The test transmission interface can be used for electrically connecting with the transmission interface under test of the computer. The processing unit includes an obtaining module and a simulation module. When the access instruction is received through the test transmission interface from the transmission interface under test of the computer, the obtaining module obtains a number of accessed blocks from the access instruction. The simulation module simulates a step of accessing a set of accessed data with the number of accessed blocks with respect to the transmission interface under test via the test transmission interface.

According to one embodiment of the present invention, the simulation module includes a reading emulator. When the access instruction is a reading instruction, the reading emulator is used to produces the data with the number of accessed blocks and returns the data with the number of accessed blocks back to the transmission interface under test of the computer.

According to another embodiment of the present invention, the simulation module further includes a reading-finished device. After returning the data with the number of accessed blocks back to the transmission interface under test of the computer is finished, the reading-finished device is used to return a reading-finished message back to the transmission interface under test of the computer through the test transmission interface.

According to another embodiment of the present invention, the simulation module includes a writing emulator. When the access instruction is a writing instruction, the writing emulator is used to receive the data with the number of accessed blocks from the transmission interface under test of the computer through the test transmission interface. After receiving the data with the number of accessed blocks is achieved, the writing emulator returns a write completed message back to the transmission interface under test of the computer through the test transmission interface.

According to another embodiment of the present invention, the processing unit further includes a virtual hard disk module. The virtual hard disk module is used to transfer at least one virtual hard disk configuration file to the transmission interface under test of the computer through the at least one test transmission interface. The virtual hard disk drive is considered as a physical hard disk drive by the computer according to the at least one virtual hard disk configuration file.

According to another embodiment of the present invention, the virtual hard disk configuration file includes a data of device type, and the virtual hard disk module includes a type configurator. The type configurator sets the data of device type in the virtual hard disk configuration file to a type of direct access block device. The virtual hard disk configuration file marked is transferred by the virtual hard disk module.

According to another embodiment of the present invention, the virtual hard disk configuration file includes an data of device capacity, and the virtual hard disk module includes a capacity configurator. The capacity configurator sets the data of device capacity in the virtual hard disk configuration file to a specific capacity. Thus, the computer recognizes the virtual hard disk drive as the physical hard disk drive with the specific capacity according to the virtual hard disk configuration file marked.

According to another embodiment of the present invention, the test transmission interface supports Small Computer System Interface (SCSI) interfaces, Serial Attached SCSI (SAS) interfaces, or Fibre Channel (FC).

According to the aforementioned embodiments of the present invention, the advantages of applying the embodiments of the present invention are as below. After an accessing instruction is received from a computer, the virtual hard disk drive can emulate the actions of accessing data. Moreover, the actions of accessing data are emulated by the processing unit, and thereby will not be limited by the access speed of a read-write head. In other words, according to one embodiment of the present invention, the virtual hard disk drives can obtain an access speed, which is faster than that obtained by the traditional hard disk drives. Furthermore, in one embodiment of the present invention, one virtual hard disk drive can emulate several physical hard disk drives at the same time. Thus, when a pressure test is performed on is transmission interfaces of a computer via a virtual hard disk drive according to One embodiment of the present invention, the limitations caused by access speed of traditional hard disk drives or caused by damaged sectors of traditional hard disk drives can be avoided, and thereby the pressure test can actually present the efficiency of the transmission interface under test. Moreover, a virtual hard disk drive has no risks of damaged sectors such as that in traditional hard disk drives, thereby lowering cost of the pressure test.

### BRIEF DESCRIPTION OF THE DRAWINGS

For the purpose that the aforementioned objects, features, advantages, and embodiments of the present invention can be more obviously and easily understood, the accompanying figures are explained as below:

FIG. 1 is a function block diagram of a virtual hard disk drive according to one embodiment of the present invention.

### DESCRIPTION OF THE PREFERRED EMBODIMENTS

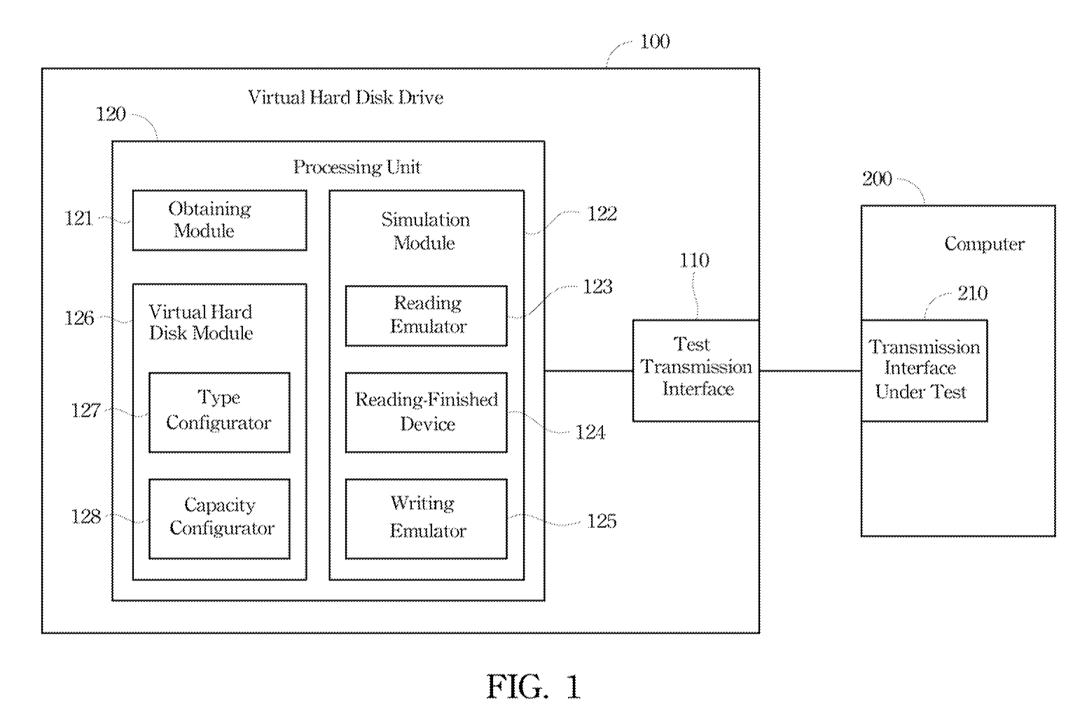

Referring to FIG. 1, FIG. 1 is a function block diagram of a virtual hard disk drive according to one embodiment of the present invention. The virtual hard disk drive emulates accessing data according to an access instruction received from a transmission interface under test of a computer.

The virtual hard disk drive 100 includes the test transmission interface 110 and the processing unit 120. The test transmission interface 110 is used for electrically connecting with the processing unit 120. The test transmission interface 110 can electrically connect with the transmission interface under test 210 of the computer 200. The processing unit 120 includes the obtaining module 121 and the simulation module 122.

When an access instruction is received through the test transmission interface 110 from the transmission interface under test 210 of the computer 200, the obtaining module 121 obtains a number of accessed blocks from the access instruction. The obtaining module 121 can account the number of accessed blocks from the access instruction via the start address and the terminal address of the data accessed by the access instruction. Moreover, the obtaining module 121 can directly obtain the number of accessed blocks from the column in which the number of accessed blocks from the access instruction is stored. However, in some certain embodiments, the obtaining module 121 can obtain the number of accessed blocks from the access instruction via other methods that are not limited to this embodiment.

The simulation module 122 simulates a step of accessing a set of accessed data with the number of accessed blocks with respect to the transmission interface under test 210 of the computer 200 via the test transmission interface 110. The access instruction can be a reading instruction or a writing instruction. Therefore, the simulation module 122 can include the reading emulator 123 or the writing emulator 125.

When the access instruction is a reading instruction, the reading emulator 123 produces and returns data with the number of accessed blocks back to the transmission interface under test 210 of the computer 200, wherein the data produced by the reading emulator 123 can be the predetermined data or the data produced randomly. Therefore, the computer 200 can emulate reading data through the transmission interface under test 210 via the virtual hard disk drive 100.

Moreover, after the data with the number of accessed blocks has been transferred back to the computer 200, the virtual hard disk drive 100 can inform the computer 200 that the action of reading data is finished. Therefore, the simulation module 122 can include reading-finished device 124 which is used to return a reading-finished message back to the transmission interface under test 210 of the computer 200 through the test transmission interface 110 after the data with the number of accessed blocks has been returned back to the computer 200. Thus, the computer 200 can recognize that the action of reading data is finished according to the reading-finished message.

When the access instruction is a writing instruction, the writing emulator 125 receives data with the number of accessed blocks from the transmission interface under test 210 of the computer 200 through the test transmission interface 110. After the data with the number of accessed blocks has been received, the writing emulator 125 returns a write completed message back to the transmission interface under test 210 of the computer 200 through the test transmission interface 110. Therefore, the computer 200 can emulate writing data through the transmission interface under test 210 via the virtual hard disk drive 100.

Moreover, the virtual hard disk drive can be considered as at least one physical hard disk drive by the computer 200. Therefore, the processing unit 120 can include a virtual hard disk module 126 used to transfer a virtual hard disk configuration file to the transmission interface under test 210 of the computer 200 through the test transmission interface 110. Thus, the virtual hard disk drive can be considered as the physical hard disk drive by the computer 200 according to the virtual hard disk configuration file.

However, in some certain embodiments, the virtual hard disk drive 100 can include several test transmission interfaces. After the test transmission interfaces have electrically connected with the transmission interface under test 210 of the computer 200, and each of the virtual hard disk configuration files has been transferred respectively through each of the test transmission interfaces, the virtual hard disk drive can be considered as several physical hard disk drives by the computer 200.

Moreover, a virtual hard disk configuration file can include an data of device type or an data of device capacity, and the virtual hard disk module 126 can include a type configurator 127 or a capacity configurator 128. The type configurator 127 sets the data of device type in the virtual hard disk configuration file to a type of direct access block device. The virtual hard disk configuration file marked is transferred to the transmission interface under test 210 of the computer 200 by the virtual hard disk module 126. Thus, the computer 200 recognizes the virtual hard disk drive 100, which has emulated a physical hard disk drive, as a direct access block device according to the data of device type in the virtual hard disk configuration file.

The capacity configurator 128 sets the data of device capacity in the virtual hard disk configuration file to a specific capacity. The specific capacity can be set as different capacities according to the capacities of the physical hard disk drives desired to be emulated. Thus, the computer 200 recognizes the virtual hard disk drive 100 as a physical hard disk drive with the specific capacity according to the virtual hard disk configuration file.

Further, the test transmission interface 110 of the virtual hard disk drive 100 and the transmission interface under test 210 of the computer 200 can support Small Computer System Interface (SCSI) interfaces, Serial Attached SCSI (SAS) interfaces, Fibre Channel (FC) or other transmission interfaces. Thus, when a pressure test is performed on the transmission interface under test 210 of the computer 200, the virtual hard disk drive 100 can be used to replace physical hard disk drives.

According to the aforementioned embodiments of the present invention, the advantages of applying the embodiments of the present invention are as below. After an accessing instruction is received from a computer, the virtual hard disk drive can emulate the actions of accessing data. Moreover, the actions of accessing data are emulated by the processing unit, and thereby will not be limited by the access speed of a read-write head. In other words, according to one embodiment of the present invention, the virtual hard disk drives can obtain an access speed, which is faster than that obtained by the traditional hard disk drives. Furthermore, in one embodiment of the present invention, one virtual hard disk drive can emulate several physical hard disk drives at the same time. Thus, when a pressure test is performed on transmission interfaces of a computer via a virtual hard disk drive according to one embodiment of the present invention, the limitations caused by access speed of traditional hard disk drives or caused by damaged sectors of traditional hard disk drives can be avoided, and thereby the pressure test can actually present the efficiency of the transmission interface under test. Moreover, a virtual hard disk drive has no risks of damaged sectors such as that in traditional hard disk drives, thereby lowering cost of the pressure test.

Although the present invention is disclosed with embodiments as above, it is not used to limit the present invention, and any one skilled in the art can make various changes and modifications without departing from the spirit and range of the present invention. Therefore, the contents of the present invention under protection depend on the following claims.

What is claimed is:

1. A virtual hard disk drive comprising:
at least one test transmission interface used for electrically connecting with a transmission interface under test of a computer; and
a processing unit electrically connected to the test transmission interface, the processing unit comprising:
an obtaining module, wherein when an access instruction is received through the test transmission interface from the transmission interface under test of the computer, the obtaining module obtains a number of accessed blocks from the access instruction; and
a simulation module used for simulating a step of accessing a set of accessed data with the number of accessed blocks with respect to the transmission interface under test via the test transmission interface.

2. The virtual hard disk drive of claim 1, wherein the simulation module further comprises:
a reading emulator used for producing the accessed data with the number of accessed blocks and returning the accessed data with the number of accessed blocks back to the transmission interface under test of the computer when the access instruction is a reading instruction.

3. The virtual hard disk drive of claim 2, wherein the simulation module further comprises:
a reading-finished device used for returning a reading-finished message back to the transmission interface under test of the computer through the test transmission interface after returning the data with the number of accessed blocks back to the transmission interface under test of the computer is finished.

4. The virtual hard disk drive of claim 1, wherein the simulation module further comprises:
a writing emulator used for receiving the data with the number of accessed blocks from the transmission interface under test of the computer through the test transmission interface when the access instruction is a writing instruction, wherein after receiving the data with the number of accessed blocks is achieved, the writing emulator returns a write completed message back to the transmission interface under test of the computer through the test transmission interface.

5. The virtual hard disk drive of claim 1, wherein the processing unit is further comprises:
a virtual hard disk module which transfers at least one virtual hard disk configuration file to the transmission interface under test of the computer through the at least one test transmission interface, wherein the virtual hard disk drive is considered as a physical hard disk drive by the computer according to the at least one virtual hard disk configuration file.

6. The virtual hard disk drive of claim 5, wherein the virtual hard disk configuration file comprises data of device type, and the virtual hard disk module comprises:
a type configurator used for setting the data of device type in the virtual hard disk configuration file to a type of direct access block device, wherein the virtual hard disk configuration file marked is transferred by the virtual hard disk module.

7. The virtual hard disk drive of claim 5, wherein the virtual hard disk configuration file comprises data of device capacity, and the virtual hard disk module comprises:
a capacity configurator used for setting the data of device capacity in the virtual hard disk configuration file to a specific capacity, wherein the computer recognizes the virtual hard disk drive as the physical hard disk drive with the specific capacity according to the virtual hard disk configuration file marked.

8. The virtual hard disk drive of claim 1, wherein the test transmission interface supports Small Computer System Interface (SCSI) interfaces, Serial Attached SCSI (SAS) interfaces, or Fibre Channel (FC).
